(19) United States
(12) Patent Application Publication
(10) Pub. No.: US 2019/0241048 A1
(43) Pub. Date: Aug. 8, 2019

(54) EXTERNAL VEHICLE WINDOW GLASS PROTECTION AGAINST SHARP OBJECTS

(71) Applicant: Luoyu Roy Xu, El Paso, TX (US)

(72) Inventor: Luoyu Roy Xu, El Paso, TX (US)

(21) Appl. No.: 16/257,030

(22) Filed: Jan. 24, 2019

Related U.S. Application Data
(60) Provisional application No. 62/627,193, filed on Feb. 6, 2018.

(51) Int. Cl. B60J 1/20; B60J 11/08

(52) U.S. Cl. CPC B60J 1/2094; B60J 11/08

(57) ABSTRACT

An external vehicle window glass protection system for protecting against static or moving sharp objects. It includes a relatively soft and lightweight layered armor panel, and a releasable mounting system to mount the armor panel on a vehicle door to cover the glass window. The layered armor panel has at least two layers of materials: an outer hard material layer to provide stab resistance and yield large plastic deformation/damage, and an inner soft material layer to reduce the contact force and absorb or dissipate kinetic energy of moving sharp object. The armor panel mounting system has an armor package with the armor panel inside, a back sheet behind the vehicle door folded around the large curved door edge to provide vertical constraint, and a side sheet folded around the vertical edge of the door to provide horizontal constraint. These two sheets are releasably connected using fasteners.

### BACKGROUND OF THE INVENTION

### Field of the Invention

The present invention relates to an external vehicle window glass protection system including a relatively soft and lightweight layered armor panel, and a releasable mounting system on a vehicle door to protect the glass window.

### Description of Related Art

Vehicle theft is a worldwide crime. Casual thieves often break vehicle windows to steal valuable items. Unlike the front windshields which uses laminated glass, side windows of vehicles are designed to be weak such that the driver and passengers can break the window glass to escape during an emergency. As a result, a thief also can break the side window easily using a sharp hammer or other sharp objects such as stones. A current protection technology against window smash is to bond an internal safety film on the window glass facing the driver. However, many drivers do not use these safety films due to several reasons: 1) drivers often feel difficult to bond these films on the glass, and the films may get many bubbles over period of use, 2) a thief still can break glass outside, because the function of the film is to hold the broken glass pieces together, not to prevent fracture. So, the driver still has to repair the fractured glass that had internal film protection. The major advantage of the film is that the thief may need extra time to penetrate the glass (e.g., the thief may need 30 seconds, rather than three seconds to break the window), 3) the film strengthens window glass internally, but it is hard for the driver to break the glass from inside the vehicle during the emergency. So, the safety film leads to a big safety concern.

### SUMMARY

Accordingly, the present invention is directed to a vehicle side window protection system that substantially obviates one or more of the problems due to limitations and disadvantages of the related art.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides an external vehicle window protection system which includes two integrated parts: 1) a relatively soft layered armor panel, which is imbedded inside an armor panel mounting system, and 2) an armor panel mounting system on the vehicle door to cover the vehicle window. The protection system is releasable.

The layered armor panel has at least two kinds of materials: a hard material which directly contacts the sharp object to provide stab resistance and yield large plastic deformation/damage, and a soft material which is placed in front of the glass to reduce the contact force and absorb or dissipate kinetic energy of the moving sharp object.

The armor panel mounting system has at least three parts: 1) an armor package with the armor panel inside, 2) a back sheet behind the vehicle door covers the large curved door edge to provide the vertical constraint, and 3) a side sheet covers the vertical edge of the vehicle door to provide the horizontal constraint. These two sheets are connected and released using special connection materials such as Velcro strips.

In one aspect, the present invention provides an external vehicle window protection system which includes: a layered armor panel; and an armor panel mounting structure, having a first part, a second part, and a third part which are made of fabric materials and are joined together, wherein the armor panel is imbedded inside the first part of the armor panel mounting structure, wherein the second part overlaps the first part and is joined to the first part at a top curved edge of the first part and a top curved edge of the second part, wherein the third part is joined to a side edge of the first part, wherein the armor panel mounting structure further includes a releasable fastener configured to secure the third part and the second part together when the third part is folded along the side edge toward the first part.

It is to be understood that both the foregoing general description and the following detailed description are exemplary and explanatory and are intended to provide further explanation of the invention as claimed.

### BRIEF DESCRIPTION OF THE DRAWINGS

FIG. 1 shows an external window protection system mounted on a passenger vehicle door according to an embodiment of the present invention.

FIG. 2 shows a cross-sectional view of layered window armor which can be in embodiments of the present invention, against a sharp object.

FIG. 3 schematically illustrates the structure of a vehicle window protection system according to an embodiment of the present invention.

FIG. 4 illustrates the structure of a vehicle window protection system according to an embodiment of the present invention.

FIG. 5 shows an example of a relatively soft armor panel which may be used in the vehicle window protection system according to embodiments of the present invention.

### DETAILED DESCRIPTION OF PREFERRED EMBODIMENTS

Embodiments of the present invention provide an external vehicle window glass protection system. The system includes a relatively soft and lightweight layered armor panel, and a releasable mounting system for mounting the armor panel on a vehicle door to cover the glass window.

The vehicle window glass protection system includes two integrated parts: 1) a relatively soft and lightweight layered armor panel, the functions of which include dissipating or absorbing kinetic energy of a moving sharp object, and reducing the high local stress of the glass caused by the sharp object; and 2) an armor panel mounting system for securing the armor panel on the vehicle door. After the driver leaves the car, the protection system can cover the vehicle side window. Before the driver enters the car, the system can be released easily. This vehicle window glass protection system has more functions than the conventional safety film protection, because it 1) has significant visible protection to any potential thief, while the safety film protection is hardly visible, 2) block a thief's view, 3) block sunshine during summer, 4) reduce hail damage, 5) minimize the influence of snow or ice during winter. The benefits for the users include light weights, low prices compared to window replacement, and peace of mind. Tests conducted by the inventor show that when the protection system was hit by a sharp emergency hammer hardly more than five minutes, the glass window has no crack at all.

Glass has very little plastic deformation for energy dissipation when it is subjected to a point force (or force over a very small contact area) caused by a sharp object. If a sharp hammer or knife is used to push or hit the glass, the principal tensile stress under the sharp object would reach the glass tensile strength quickly and break the glass. Therefore, an external protection system should have at least two functions: 1) reducing the maximum tensile stress inside the glass. For example, the concentrated force from the sharp object will be changed to a distributed force over a large contact area. Also, the contact force will be reduced by placing a soft material in front of the hard glass, 2) absorbing and dissipating kinetic energy of the sharp object if the object is moving. As a result, the maximum dynamic contact stress on the glass will be reduced. Indeed, there are many external material combinations for the above purposes. However, the present material combination has several advantages because it is cost-effective, flexible (or soft) and light.

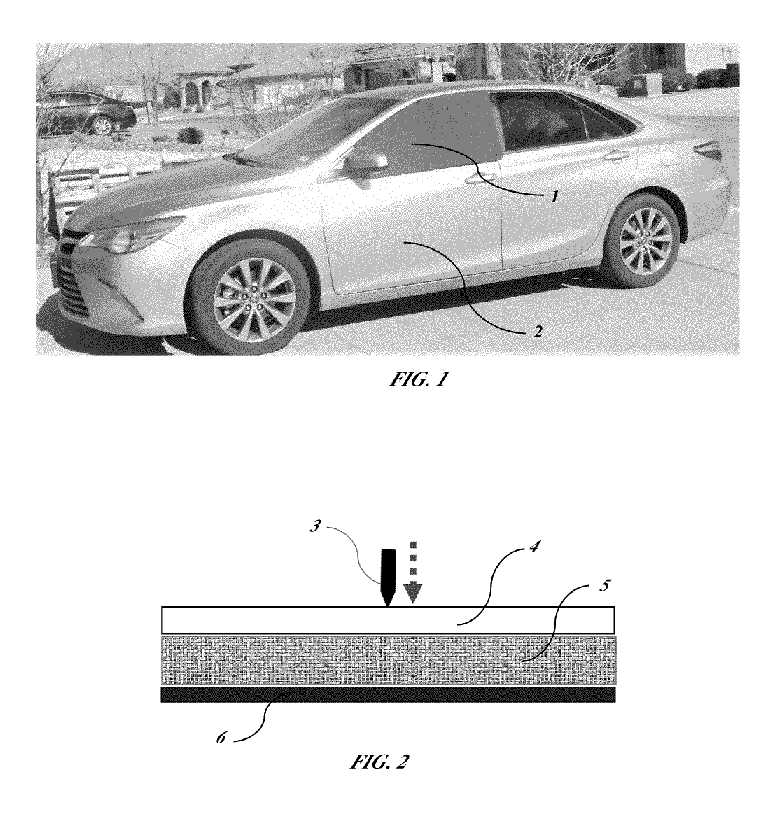

FIG. 1 shows an external window protection system 1 mounting on a passenger vehicle door 2, after the driver leaves the vehicle. Since the windows of different vehicles are often different, the size of the armor panel is based on the average window sizes, or it can be made to exactly fit specific car models.

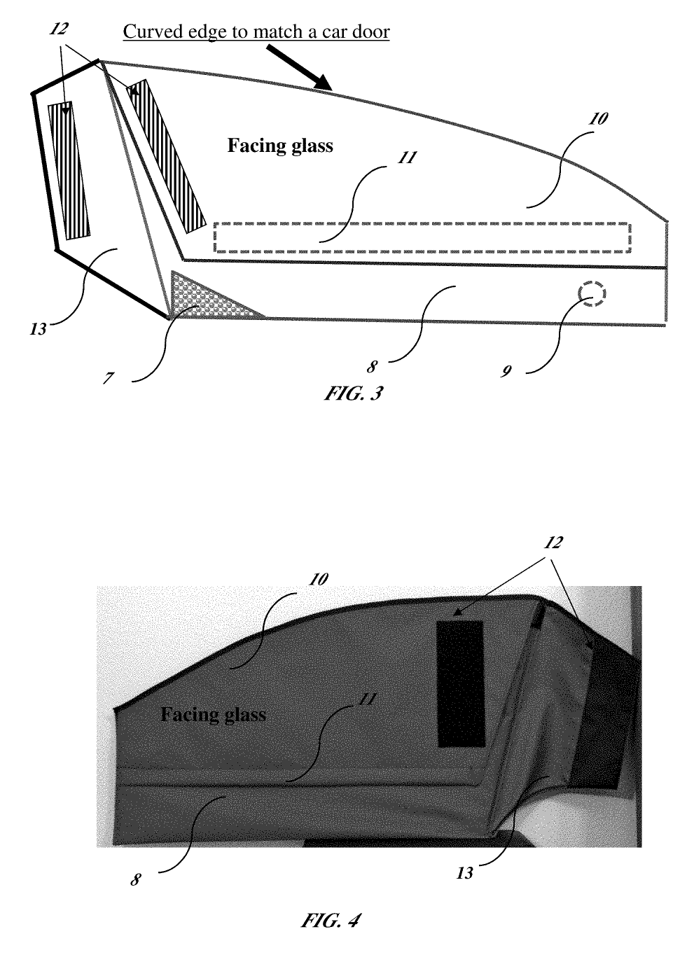

FIG. 2 shows a cross-sectional view of a layered window glass protection armor against a sharp object 3 such as a sharp hammer or knife. The protection armor includes at least two kinds of materials in a stack: a hard material 4 which directly (via the armor package, not shown in FIG. 2) meets the sharp object, and a soft material 5 which is placed adjacent to (via the armor package, not shown in FIG. 2) the vehicle window glass 6. There is no fixed bonding between the window glass 6 and the protection system. Other materials can be added for additional functions or enhancing current function.

The definitions of hard and soft materials here are based on their Young's moduli. Preferably, the Young's modulus of the hard material is at least 10 times that of the soft material. Also, the Young's modulus of glass is around 70 GPa, therefore, the Young's modulus of the soft material is preferably below 0.1 GPa to reduce the contact force between the soft material and the glass. The Young's modulus of the hard material is at least 1 GPa, but its high modulus is not recommended since the rigidity of the whole armor panel will increase.

The hard material is a solid or continuous material, not a porous material, while the soft material can be a porous material. The hard material is necessary because it can provide enough stab resistance against the sharp object. An important requirement of the hard material is its large plastic deformation capability when it is pushed or hit by a sharp object. Therefore, a point load caused by the sharp object will yield a large distributed load acting on the next material (e.g., soft material) behind the hard material, so the maximum tensile stress inside the glass will be reduced, or the glass will not fracture. The hard materials can be metals, composites, or plastics (preferred). A disadvantage of metals is that they increase the rigidity and the weight of the armor panel because of their high Young's moduli, because the users do not like a stiff and heavy protection system.

The bending modulus is employed to quantify the rigidity of an armor panel. The armor panel is preferably relatively soft, so it can fit many different vehicle doors/windows which have different curvatures. Preferably, no adhesive bonding or other bonding is present between the hard material, the soft material, and other optional layered materials, because adhesive bonding will increase the bending modulus of the armor panel. For example, the bending modulus of two identical beams without bonding is only 25% of that of two bonded identical beams according to mechanics of materials.

The soft material is used to reduce the contact stiffness/force between the armor panel and the glass according to contact or impact mechanics. Some soft materials such as rubber will absorb kinetic energy from the moving sharp object, i.e., kinetic energy is converted into potential energy of rubber in the form of the strain energy. A disadvantage of these materials is that the total energy remains the same, no dissipation (reduction). Some soft materials such as foams and honeycombs will dissipate kinetic energy in the form of plastic deformation and damage, so the total energy will decrease. Because the maximum contact or impact force is an increasing function of kinetic energy, kinetic energy dissipation/reduction is preferred for the armor panel; thus, foams and honeycombs are preferred as the soft material used in the armor panel.

An important armor design parameter is the thickness of each layered material, which is mainly determined by the threat level (shape, energy, mass of the sharp object). Due to the high variations of material properties, it is not feasible to present a simple rule for armor thickness designs. Here, a simple example is presented. If the sharp object is an emergency hammer with a sharp steel tip (weight of 0.1 kg), and kinetic energy of 10 joules, the thickness of the hard material polycarbonate should be at least 0.74 mm, and the thickness of the soft material honeycomb should be at least 6.45 mm. Test results showed that the glass had no crack after more than 100 hammer hits on the armor panel. If kinetic energy of the sharp object is doubled, the above thicknesses should be at least doubled.

FIG. 3 is an illustration of the structure of a vehicle window protection system according to an embodiment of the present invention. The view in FIG. 3 is from inside the vehicle looking out, and the configuration shown in FIG. 3 is for the driver side window. The armor panel 7 is sewn inside the armor package or pocket 8 (with edges 8A-8D), which is placed outside and in front of the vehicle window/door. In order to constrain the lower edge of the armor package, magnetic blocks or discs 9 are implanted into the lower part of the armor panel before the armor panel is sewn inside the armor package. The number of the magnetic blocks or discs are determined by the pulling force of the magnetic blocks/discs. For example, if the pulling force of the magnetic block/disc is 530 N, two to three magnetic blocks/discs are recommended, so an adult (thief) cannot easily pull the protection system.

A back sheet 10 (with edges 10A-10D) is sewn together with the armor package 8 along the upper curved edge 8A, 10A; the back sheet and the armor package overlap each other to form a fold. When mounted, the back sheet 10 is placed inside the vehicle behind the vehicle window to support the armor panel. Therefore, the weight of the protection system is mainly carried by the sewn upper curved edge 8A, 10A which rest on the similarly shaped edge of the vehicle door.

An elongated, rigid bar 11 is optionally sewn inside the back sheet 10 and its functions may include balancing the armor panel weight, easily holding the back sheet by the user, and stopping any pulling of the armor panel from outside, because the thickness of the balance bar (at least 12 mm) is much larger than the gap between the vehicle door and the door frames. The material for the balance bar may be some lightweight materials such as woods, plastics or composites, other any other suitable materials.

A side sheet 13, which is an extension of the armor package 8 along a side 8B, is used to cover a part of one side edge of the vehicle door (the edge that is exposed when the door is open) and provide the horizontal constraint for the armor panel. When mounted, the side sheet is folded back and located behind the window glass, and several hook-and-loop releasable fastener (Velcro®) strips 12 are provided on the side sheet and the back sheet 10, which connect the back sheet and the side sheet to firmly mount the armor panel on the door. Preferably, the width of the side sheet 13 is at least three inches such that the same armor mounting system can fit vehicle doors with different widths.

As indicated earlier, the armor panel 7 includes a layer of hard material and a layer of soft material; the hard material is located on the side farther away from the back sheet 10 and the soft material is located on the side closer to the back sheet 10, so the harder material faces outwards against impact and the soft material faces the window.

The package 8, the back sheet 10 and the side sheet 13 are preferably made of durable fabric materials, or other suitable flexible materials. These three parts may be separate pieces sewn together, or integrally joined together (for example, the side sheet 13 may be a continuous piece with a sheet of the package 8). The hook-and-loop fastener may be replaced by other suitable releasable fasteners, such as snaps, buckles, zippers, hooks, ties, etc.

In use, while the vehicle door is open, the vehicle window protection system is placed over the upper curved edge of the door, with the package 8 outside the window and back sheet 10 behind the window, and the curved upper edge 8A, 10A of the package 8 and back sheet 10 resting on the upper curved edge of the door. The side sheet 13 is folded over the side edge of the door to the inside of the window, and secured to the back sheet 10 by the hook-and-loop strips. The vehicle door is then closed.

The inventor constructed a vehicle window protection system having the above described structure, as shown in FIG. 4. The material used for the package is waterproof Nylon 500 D fabrics. This armor mounting system is for the passenger side window protection. The overall length and the height of the protection system are about 1.0 meter and 0.55 meter, respectively. This protection system fits many popular cars such as Toyota Camry and Honda Accord.

In most of the thief cases, a thief breaks the windows of the driver side and the front passage side, so two protection systems for two windows are often sufficient.

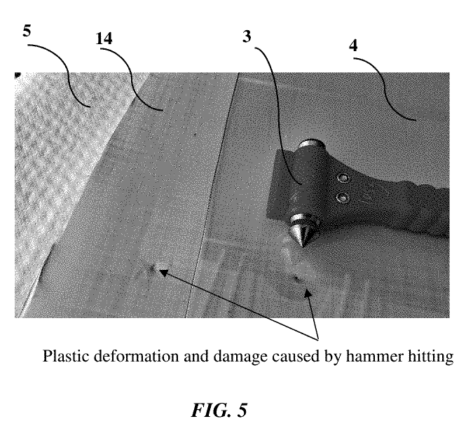

FIG. 5 shows an example of a typical armor panel including a hard material, polycarbonate sheet 4 (thickness 0.74 mm), a soft material, polypropylene honeycomb sheet 5 (thickness 6.45 mm), and an optional Ultra-High-Molecular-Weight Polyethylene (UHMWPE) ballistic fabric sheet 14 (thickness 0.2 mm) between the polycarbonate and honeycomb sheets. After the armor panel was struck by an adult using a sharp hammer 3, visible plastic deformation and damage inside polycarbonate sheet and UHMWPE sheet was seen, while no visible plastic deformation damage was found in the honeycomb. As a result of the energy dissipation mechanism of this invention, there was no crack found on the window glass behind the protection system, even after the protection system was struck more than 100 times by the sharp hammer (more than three minutes).

The UHMWPE ballistic fabric sheet has major functions of both hard and soft materials, because it can yield large plastic deformation/damage like the hard material, and its Young's modulus is close to that of the soft material. However, the key shortcoming is its high cost. Therefore, this is an optional material to be used in the armor panel.

It will be apparent to those skilled in the art that various modification and variations can be made in the vehicle window protection system of the present invention without departing from the spirit or scope of the invention. Thus, it is intended that the present invention cover modifications and variations that come within the scope of the appended claims and their equivalents.

What is claimed is:

1. An external vehicle window protection system comprising:
an armor panel; and
an armor panel mounting structure, having a first part, a second part, and a third part which are made of flexible sheet materials and are joined together,
wherein the armor panel is imbedded inside the first part of the armor panel mounting structure,
wherein the second part overlaps the first part and is joined to the first part at a top curved edge of the first part and a top curved edge of the second part,
wherein the third part is joined to a side edge of the first part,
wherein the armor panel mounting structure further includes a releasable fastener configured to secure the third part and the second part together when the third part is folded along the side edge toward the first part.

2. The external vehicle window protection system of claim 1, wherein the armor panel includes at least a hard material member and a soft material member stacked together, wherein the soft material member is located closer to the second part of the armor panel mounting structure than the hard material is.

3. The external vehicle window protection system of claim 2, wherein the hard material member is a polycarbonate sheet, and the soft material member is a polypropylene honeycomb sheet.

4. The external vehicle window protection system of claim 3, wherein the armor panel further includes an Ultra-High-Molecular-Weight Polyethylene (UHMWPE) ballistic fabric sheet disposed between the polycarbonate sheet and the polypropylene honeycomb sheet.

5. The external vehicle window protection system of claim 1, further comprising an elongated, rigid bar embedded in the second part of the armor panel mounting structure.

6. The external vehicle window protection system of claim 1, further comprising one or more magnets embedded in the first part of the armor panel mounting structure near a bottom edge of the first part.
